(19) United States
(12) Patent Application Publication
(10) Pub. No.: US 2010/0319202 A1
(43) Pub. Date: Dec. 23, 2010

(54) BODY STRUCTURE OF HAIRDRESSING SCISSORS

(76) Inventor: Tzu-Yung Lin, Chung-Ho City (TW)

Correspondence Address: HDLS Patent & Trademark Services, P.O. BOX 220746, CHANTILLY, VA, 20153-0746, US

(21) Appl. No.: 12/488,757

(22) Filed: Jun. 22, 2009

(51) Int. Cl. B26B 13/00

(52) U.S. Cl. 30/226; 30/254

(57) ABSTRACT

A body structure of a hairdressing scissor includes two body portions pivotally connected with each other. Each of the body portions includes a handle and a knife edge. The handle has a first connection section extended from one end thereof and having a notch defined thereon. The knife edge has a convex second connection section extended from one end thereof and fitted to the notch. The handle can be firmly assembled with the knife edge when corresponding connection sections with fitted shapes are engaged together.

### BACKGROUND OF THE INVENTION

1. Field of the Invention

The present invention in general relates to a hairdressing scissor, in particular, to a body structure of hairdressing scissor.

2. Description of Prior Art

When hairstyle designer is cutting hair, hairdressing scissor is one of the most necessary and important tools. Since designer takes a longtime to grip the hairdressing scissor and operate hair cutting, the factors related to the hairdressing scissor, such as weight and material, are very important substantially. However, the purpose of the knife edge of the hairdressing scissor is to cut hairs, so it is made of a better material. On the other hand, the handle is only to be held by the user to operate the hair cutting, so the chosen material of the handle can be different from that of knife edge, based upon the aforementioned considerations, such as, weight, material, cost and the gripping feel.

As mentioned thereinbefore, based upon the considerations of cost-saving and gripping feel promotion, most hairdressing scissor 2 sold on the market includes a pair of body portions 20, as shown in FIG. 1. As seen in this figure, via a screwing element 23 (e.g., screw), a handle 21 and a knife edge 22, originally separate, are firmly combined into one body portion 20, two of which are then fitted pivotally into a hairdressing scissor via a pivoting element 24. In so doing, the handle 21 and the knife edge 22 can be interchanged randomly, collocating the selected material or configuration habitually practiced by the designer.

Additionally, there is a combined hairdressing scissor disclosed in Taiwan Patent No. 590063, in which except a screwing element 23, a plurality of rivets and bores, corresponding to each other, are arranged on the connection sections of the handle 21 and the knife edge 22, thus enhancing the firmly wedging force and making the structure of the body portion more secure.

However, in the aforementioned structure, the connection force between the handle 21 and the knife edge 22 is enhanced by attached elements (e.g., the screwing element 23 and rivet), substantially needing an additional cost in a certain degree. Furthermore, during dismantling process, the screwing element 23 is easily lost or dropped off, while the rivet has a certain inconvenience as well.

Moreover, two body portions 20 of the hairdressing scissor 2 are pivoted by the pivoting element 24 to be able to undergo corresponding closing-and-opening motion. But, in so doing, the pivoting element 24 is then exposed to the outside of two body portions 20, further making the hairdressing scissor 2 has a specific limitation in terms of aesthetic design. Furthermore, it also can cause inconvenience for using the hairdressing scissor 2.

Therefore, how to achieve a connection of two body portions of the hairdressing scissors with most perfect posture then becomes a very important issue intended to be addressed by the relative industry.

Accordingly, after a substantially devoted study, in cooperation with the application of relative academic principles, the inventor has finally proposed the present invention that is designed reasonably to possess the capability to improve the drawbacks of the prior art significantly.

### SUMMARY OF THE INVENTION

The invention is mainly to provide a body structure of a hairdressing scissor, which can make the handle and the knife edge be connected more firmly without dropping off easily, in the meantime, making the fitted body portion capable of a securer structure.

Secondly, the invention is to provide a body structure of a hairdressing scissor, which can hide the pivoting element of the hairdressing scissor via the connection structure of the body portion without exposure, further constituting a hairdressing scissor with pivoting elements hidden in double faces.

Thirdly, the invention is that the handle has a first connection section extended from one end thereof and having a notch defined thereon, while the knife edge has a convex second connection section extended from one end thereof and fitted to the notch.

Fourthly, the invention is that two corresponding through holes are respectively arranged at the second connection sections on the two knife edges that are fitted with two handles to form a hairdressing scissor, after the two knife edges are pivoted to each other via a pivoting element.

Compared with the prior arts, the functions achieved by the present invention are as the following. The connection between the handle and the knife edge is achieved by two corresponding connection sections having specific configuration without using the screw or other connection element to assemble the body portion thereby having firmness and stability. Besides, after being pivoted, two knife edges are fitted with two handles to form a hairdressing scissor, wherein the pivoting elements are hidden. In so doing, the hairs of a customer won't be stuck during a hair-cutting process, further solving the regret of longtime.

### BRIEF DESCRIPTION OF DRAWING

The features of the invention believed to be novel are set forth with particularity in the appended claims. The invention itself, however, may be best understood by reference to the following detailed description of the invention, which describes a number of embodiments of the invention, taken in conjunction with the accompanying drawings, in which:

FIG. 1 is a perspective view of a hairdressing scissors according to the prior arts;

FIG. 2 is a perspective explosive view of a first embodiment according to the present invention;

FIG. 3 is a perspective view of the first embodiment according to the present invention;

FIG. 4 is a cross-sectional view of the first embodiment according to the present invention;

FIG. 5 is a cross-sectional view of another embodiment according to the present invention;

FIG. 6 is a cross-sectional view of a further embodiment according to the present invention;

FIG. 7 is a perspective explosive view of a second embodiment according to the present invention;

FIG. 8 is a perspective explosive view of a third embodiment according to the present invention; and,

FIG. 9 is a perspective explosive view of a fourth embodiment according to the present invention.

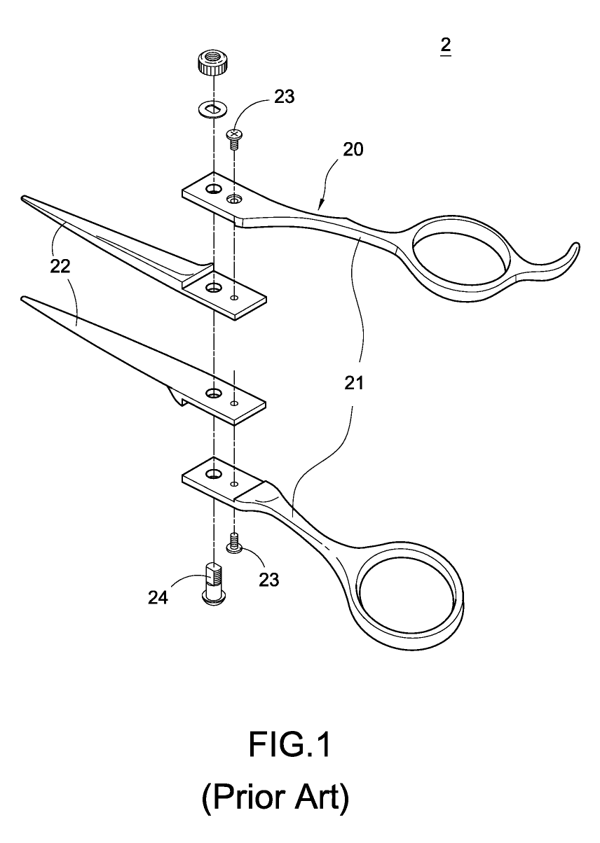

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

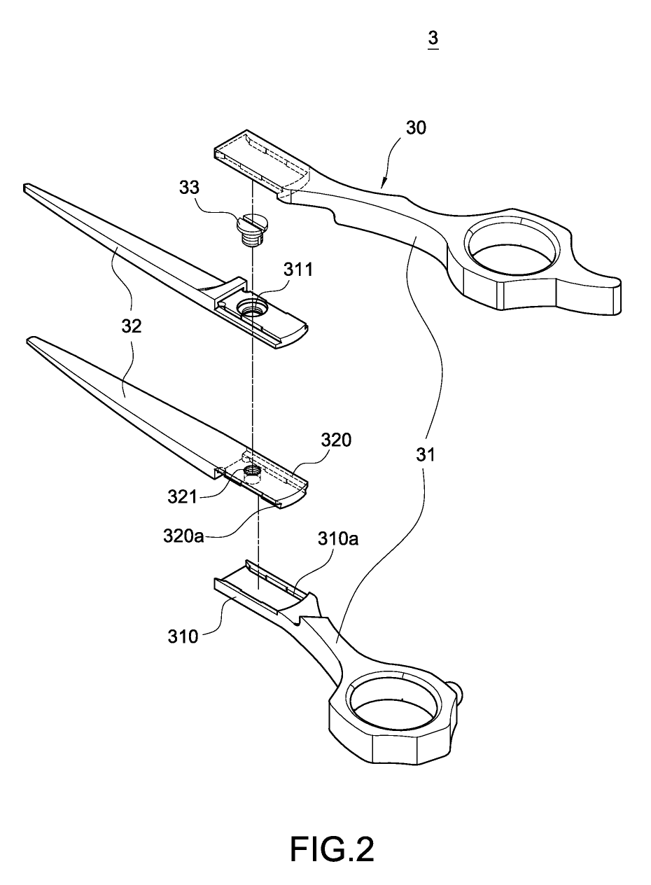

FIG. 2 is a perspective explosive view of a first embodiment according to the present invention. As shown in this figure, a hairdressing scissor 3 is commonly comprised of two body portions 30 and a pivoting element 33. The body portion 30 is formed by connecting a handle 31 and a knife edge 32. According to the invention, a first connection section 310 is extended from one end of the handle 31 and arranged a dovetail notch 310a with a notch opening narrower than a notch bottom. A convex second connection section 320 is extended from one end of the knife edge 32. A convex portion of the second connection section 320 is a dovetail seat 320a just corresponding to the dovetail notch 310a, making the two connection sections 310, 320 capable of fitting to each other, thus that the handle 31 and the knife edge can be connected firmly to form the body portion 30.

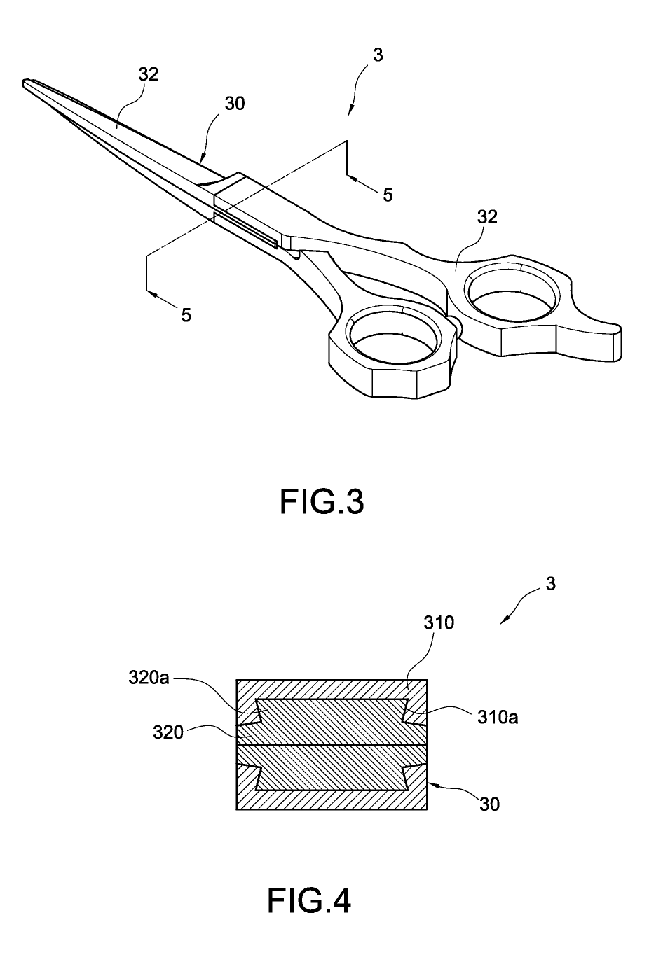

Two through holes 311, 321, corresponding to each other, are arranged respectively on the second connection sections 320 of two knife edges 32. The pivoting element 33 can pass through two through holes 311 to pivot the two knife edges 32 together. According to the body structure mentioned thereinbefore, the pivoted knife edges 32 are inter-fitted with the two handles 31 to further form a hairdressing scissor 3, as shown in FIG. 3. In so doing, the pivoting element 33 is hidden in the two body portions 30, while still not influence the normally opening-and-closing motion of the hairdressing scissor 3.

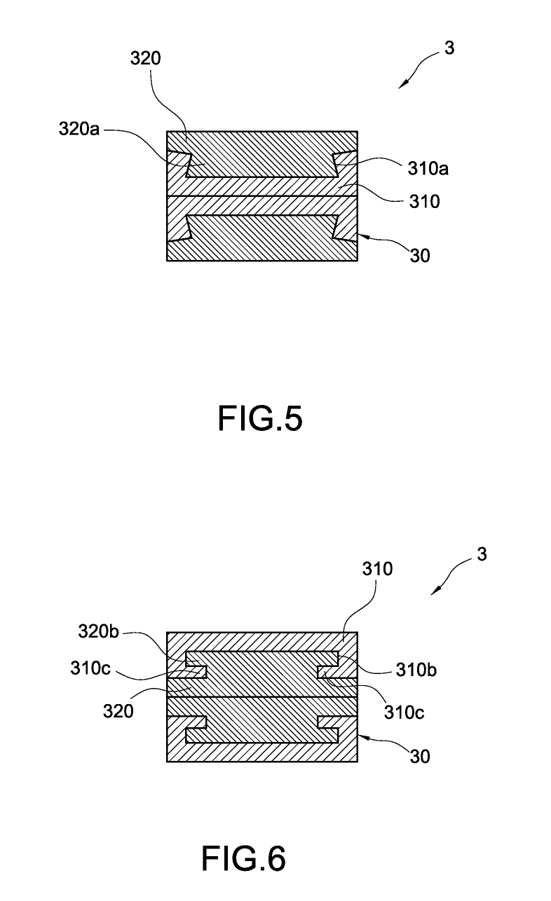

Please refer to FIG. 4 continuously, showing a cross-sectional view along a sectional line “5-5” in FIG. 3. As shown in this figure, when the first connection section 310 and the second connection section 320 are inter-fitted to each other, the dovetail notch 310a on the first connection section 310 can just accommodate the dovetail seat 320a on the second connection section 320. Also, since the notch opening of the dovetail notch 310a is narrower than the notch bottom of the dovetail notch 310a, the dovetail seat 320a can be wedged therein without dropping off easily. FIG. 5 is a cross-sectional view of another embodiment according to the present invention. As seen in FIG. 5, the positions of the two connection sections 310, 320 can be interchanged randomly; that is, the first connection section 310 can be arranged on the knife edge 32, while the second connection section 320 can be arranged on the handle 31. The interchange depends on the actual need, not limited specifically.

In the embodiments mentioned above, the first connection section 310 is arranged a dovetail notch 310a, an inner wall of which is extended from the notch bottom to the notch opening and inclined inwardly, while the second connection section 320 is arranged a dovetail seat 320a, a configuration of which corresponds to that of the dovetail notch 310a. However, the invention is not limited to the configurations of dovetail notch and dovetail seat only. FIG. 6 shows a cross-sectional view of a further embodiment of the invention. In this case, a first notch 310b is arranged on the first connection section 310, and a separating portion 310c inwardly projected is arranged at the notch opening of the first notch 310b, making the notch opening of the first notch 310b narrower than the notch bottom of the first notch 310b. The shape of a convex portion 320b arranged on the second connection section 320 is corresponded to that of the first notch 310b. When the two connection sections 310, 320 are inter-fitted to each other, the convex portion 320b can be just placed in the first notch 310b. Since the shapes of the first notch 310b and the convex portion 320b are corresponded to each other, the first notch 310b and the convex portion 320b can be fitted firmly.

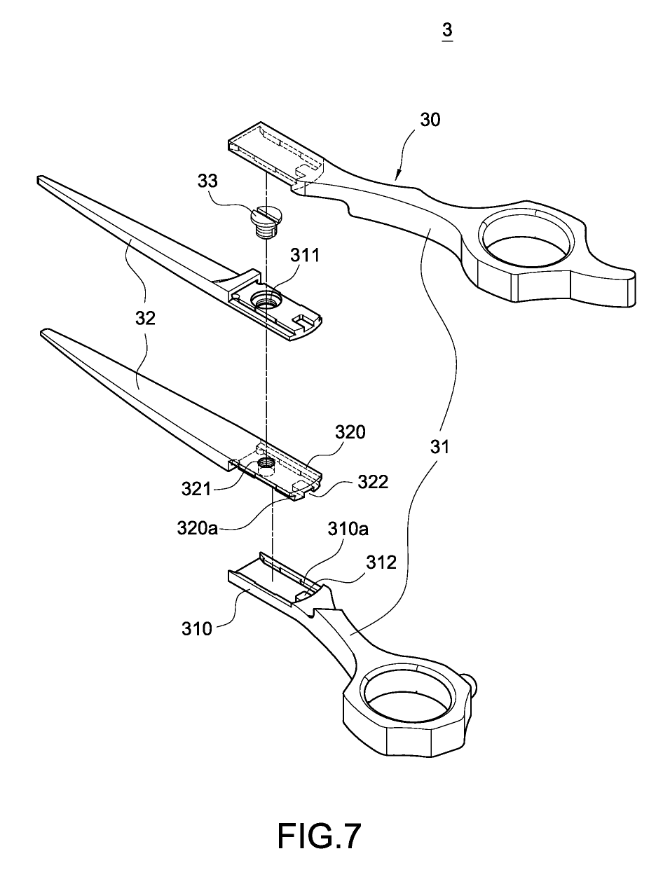

FIG. 7 shows a perspective explosive view of a second embodiment of the invention. Along the dovetail notch 310a on the first connection section 310, the handle 31 is arranged a convex block 312 at one side close to the handle 31. At one side far away the knife edge 32, the second connection section 320 is inwardly arranged a second notch 322, a notch opening of which is narrower than the notch bottom thereof. In this case, the second notch 322 and the convex block 312 can also be a dovetail notch and a dovetail seat as well, however, not limited to these only. When the two connection sections 310, 320 are inter-fitted to each other, the convex block 312 can be just placed in the second notch 322, further enhancing the wedging force between the first connection section 310 and the second connection section 320, and making the handle 31 and the knife edge 32 be fitted more firmly.

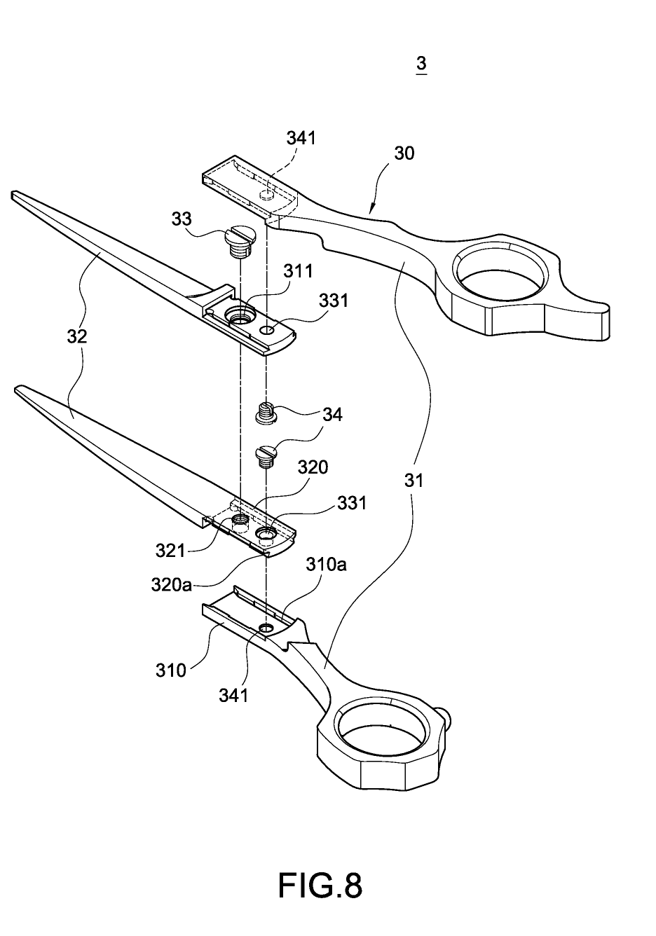

FIG. 8 shows a perspective explosive view of a third embodiment of the invention. When a user is using the hairdressing scissor of the invention with a violently using action or due to other reasons, a phenomenon of dropping off occurs, because the body structure of the invention is insufficient to use. Then, as shown in FIG. 8, a threaded hole 331 can be arranged on the second connection section 320. In the meantime, a threaded trough 341, corresponding to the threaded hole 331 and without penetrating the first connection section 310, is arranged at an inner side of the first connection section 310. In so doing, a screw element 34, from inside to outside, can securely connect the first connection section 310 and the second connection section 320. Not only is the connection structure of the body portion 30 more firmly, but also is the limit of the aesthetic design of the hairdressing scissor enhanced, without exposing the attached screw element 34 to the outside of the body portion 30.

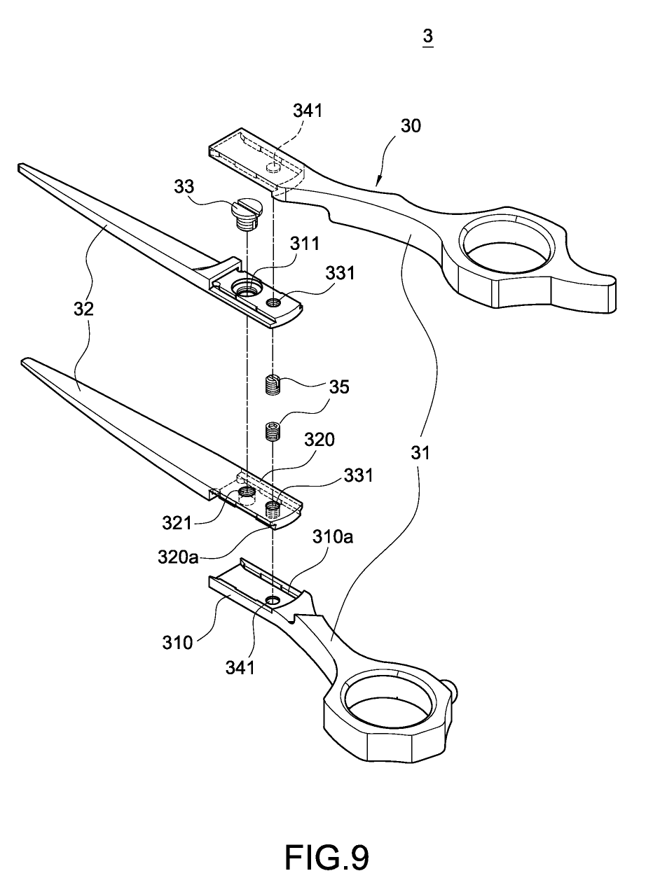

The embodiment shown in FIG. 8 can be further illustrated in FIG. 9, showing a perspective explosive view of a fourth embodiment of the invention. In this case, the screw element 34 in FIG. 8 is replaced by a headless screw 35, in a top portion of which a hexagonal recession hole is arranged. By this arrangement, the contacting area between the headless screw 35 and a surface of the second connection section 320 can be reduced, since the headless screw 35 is sunk into threaded hole 331 and screwed the threaded trough 341, which further prevents the dropping off of the headless screw 35 or other causes. Thereby, the probability influencing the closing-and-opening motion of the hairdressing scissor 3 can be reduced.

Accordingly, through the constitution of aforementioned assemblies, a body structure of a hairdressing scissors according to the invention is thus obtained.

Summarizing aforementioned description, the body structure according to the invention is an indispensably design for a hairdressing scissor indeed, which may positively reach the expected usage objective for solving the drawbacks of the prior arts, and which extremely possesses the innovation and progressiveness to completely fulfill the applying merits of new type patent, according to which the invention is thereby applied. Please examine the application carefully and grant it as a formal patent for protecting the rights of the inventor.

However, the aforementioned description is only a preferable embodiment according to the present invention, not used to limit the patent scope of the invention, so equivalently structural variation made to the contents of the present invention, for example, description and drawings, is all covered by the claims claimed thereinafter.

What is claimed is:

1. A body structure of a hairdressing scissor, the hairdressing scissor formed by two body portions, each of which includes:
a handle, which has a first connection section, on which a first notch is arranged; and,
a knife edge, which has a second connection section fitted with the first connection section, on which a convex portion is engaged with the first notch;
wherein the first notch is a dovetail notch, a notch opening of which is narrower than a notch bottom thereof, and the convex portion is a dovetail seat corresponding to the dovetail notch.

2. The body structure according to claim 1, wherein along the first notch, the handle is extended a convex block at one side close to the handle, and the second connection section is extended a second notch at one side far away the knife edge and engaged with the convex block.

3. The body structure according to claim 2, wherein the second notch is a dovetail notch, and the convex block is a dovetail seat.

4. The body structure according to claim 1, wherein a through hole is arranged on the second connection section, and wherein a pivoting element pivots the two knife edges by passing through the through hole.

5. The body structure according to claim 1, wherein a threaded trough is arranged on the first connection section, and a threaded hole corresponding to the threaded trough is arranged on the second connection section, and a screw element, from inside to outside, securely connects the two connection sections.

6. The body structure according to claim 5, wherein the screw element is a headless screw, one side of which is arranged a hexagonal recession hole.

7. A body structure of a hairdressing scissor, the hairdressing scissor formed by two body portions, each of which includes:
a knife edge, which has a first connection section, on which a first notch is arranged; and,
a handle, which has a second connection section fitted with the first connection section, on which a convex portion is engaged with the first notch;
wherein the first notch is a dovetail notch, a notch opening of which is narrower than a notch bottom thereof, and the convex portion is a dovetail seat corresponding to the dovetail notch.

8. The body structure according to claim 7, wherein along the first notch, the handle is extended a convex block at one side close to the handle, and the second connection section is extended a second notch at one side far away the knife edge and engaged with the convex block.

9. The body structure according to claim 8, wherein the second notch is a dovetail notch, and the convex block is a dovetail seat.

10. The body structure according to claim 7, wherein a through hole is arranged on the second connection section, and wherein a pivoting element pivots the two knife edges by passing through the through hole.

11. The body structure according to claim 7, wherein a threaded trough is arranged on the second connection section, and a threaded hole corresponding to the threaded trough is arranged on the first connection section, and a screw element, from inside to outside, securely connects the two connection sections.

12. The body structure according to claim 11, wherein the screw element is a headless screw, one side of which is arranged a hexagonal recession hole.
